(19) United States
(12) Patent Application Publication
(10) Pub. No.: US 2014/0131989 A1
(43) Pub. Date: May 15, 2014

(54) SECURITY DOCUMENT AND A MANUFACTURING METHOD THEREOF

(71) Applicants: Teemu Pohjola, Espoo (FI); Maila Korhonen, Helsinki (FI); Jarmo Nikkila, Vantaa (FI)

(72) Inventors: Teemu Pohjola, Espoo (FI); Maila Korhonen, Helsinki (FI); Jarmo Nikkila, Vantaa (FI)

(73) Assignee: GEMALTO SA, Meudon (FR)

(21) Appl. No.: 14/111,763

(22) PCT Filed: Apr. 13, 2012
(86) PCT No.: PCT/EP12/56827

§ 371 Date: Dec. 5, 2013

(30) Foreign Application Priority Data
Apr. 14, 2011 (EP) 11305437.3

(51) Int. Cl. B42D 15/00; B41F 17/00

(52) U.S. Cl. CPC B42D 15/0013; B41F 17/00
USPC 283/85; 101/483

(57) ABSTRACT

A security document (1-1), comprising at least a first layer (2-2) and a second layer (2-4) above the first layer (2-2), the second layer (2-4) being of optically variable ink, and one or more personalization elements, the second layer (2-4) comprising one or more wholly ink free areas (2-12, 2-16, 2-21) that are optically variable elements of the one or more personalization elements and/or one or more partly ink free areas (2-14) that are optically variable elements of the one or more personalization elements.

### FIELD OF THE INVENTION

The present invention relates to a security document and a manufacturing method thereof, and more particularly to the security document having at least one optically variable element processed by a laser personalization technique.

### BACKGROUND OF THE INVENTION

A security document like a passport is used to distinguish a person from all other persons and to verify that the person is the one claimed. Furthermore, the passport prevents an illegal travel and makes the legitimate travel easier.

The personalization of the passport means to add personal data in the passport. Said data can be printed to the passport by a printing ink. In addition to the printing ink personalization, a mark or a sign printed by a security ink can be used. Because security inks are provided in different colours, they increase security e.g. such that all the citizens of Sweden could have a yellow security ink circle printed on the passport while all the citizen of Finland could have a blue security ink circle printed on the passport. In addition to this kind of extra security marking, security inks provide an effective solution against falsification, because the trade and distribution of security inks are strictly controlled. However, the security needs to be even further increased against situations, where counterfeiters obtain blank documents or manage to erase legitimate data on stolen documents or products.

### BRIEF DESCRIPTION OF THE INVENTION

An object of the present invention is thus to provide a method and an apparatus for implementing the method so as to solve the above problem. The objects of the invention are achieved by a method and an arrangement, which are characterized by what is stated in the independent claims. The preferred embodiments of the invention are disclosed in the dependent claims.

The invention is based on the idea of adding one or more personalization layers to different security products or documents and to process it/them to make it more difficult to alter said products or documents.

An advantage of the method and arrangement of the invention is that the security of different security documents or the authenticity of different products against counterfeiting attempts is improved.

### BRIEF DESCRIPTION OF THE DRAWINGS

In the following the invention will be described in greater detail by means of preferred embodiments with reference to the attached drawings, in which

FIG. 1 shows a security document according to the invention and its embodiments;

FIG. 2 shows a part of the security document according to the invention and its embodiment; and

FIG. 3 shows a part of the personalization of the security document according to the invention and its embodiment

### DETAILED DESCRIPTION OF AT LEAST ONE EMBODIMENT

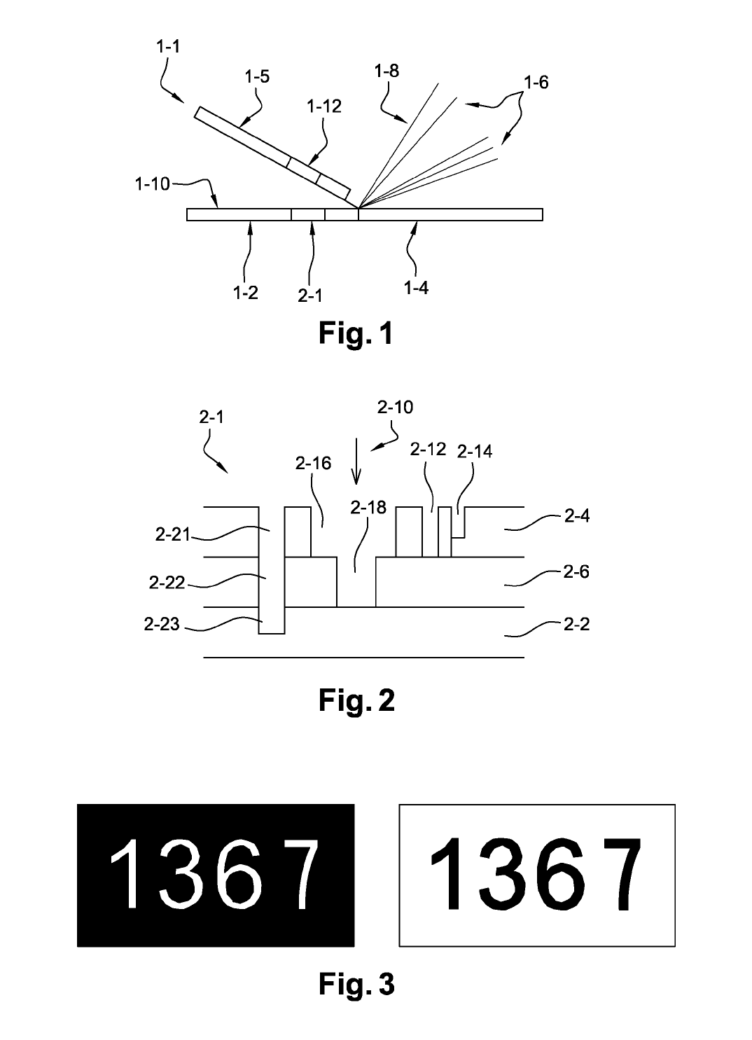

The invention and its embodiments can be applied to many different documents and products, e.g. to a passport document, an identity card, a driver's license, a credit card, a membership card, a phone card, currencies, a value document or a value product or to any other document or product requiring high security and reliability or a mark of authenticity. In addition, the document or the product can also be included e.g. in a banknote, a bond or a stamp or any other piece of paper or other material. The above-mentioned document or product provided with a security element or a security device according to the invention and its embodiment can also be used to provide control mechanisms against illicit trade to the alcohol, pharmaceuticals, food and beverages and different kinds of luxury goods, like handbags, briefcases, ballpoint pens, pencils, cigars, shoes, ties, etc. FIG. 1 shows a first embodiment of such a security document, the passport.

The passport may be provided with one or more personalization elements like a photograph of the holder, the signature of the holder and written data with information about the holder. Data of the holder can comprise lots of information, e.g. on the name, the address, the date of birth and the social security number of the holder, the serial number of the document, and the name of the issuing authority. In addition, the security document may contain a plurality of security elements and items in order to make the forgery of the security document as difficult as possible. Some or all of the data and security items may be in an electronic module attached or embedded to the document.

The document illustrated in FIG. 1 comprises a front cover 1-2, a back cover 1-4 and an inner cover 1-10 on the other side of the front cover. Between of the covers there can be inserted a data page 1-5 provided with the information described above, the first visa page 1-8 and one or more additional visa pages 1-6. On the other hand, the document or the product with one or more security marks, signs or elements first printed by a security ink and then processed can be as simple as a card with information on the holder and/or on a provider of the card and security elements on one side of the card or on both sides of the card and/or in the card, but at least on one surface of the card.

In case the security document comprises pages between the covers of the document, all of the pages can be attached to each other on one end.

Each of the pages and each of the covers can comprise one or more windows 1-12 for making the personalization of the document or for assisting in making the personalization of the document. In FIG. 1 the data page includes one window or one window area 1-12.

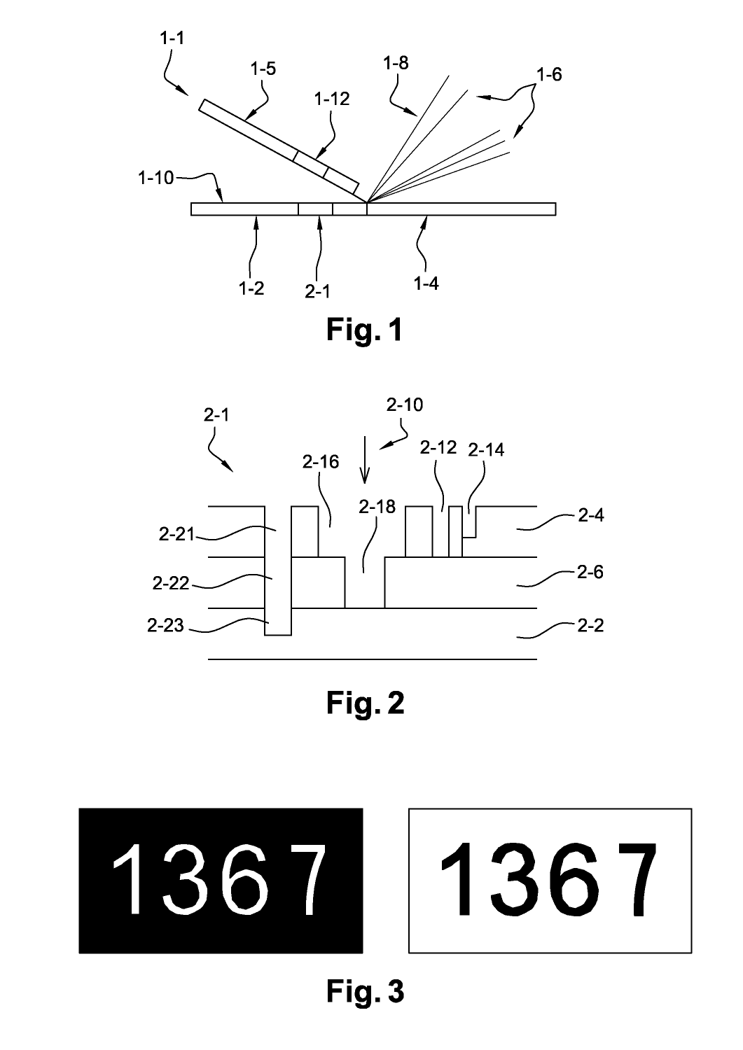

FIG. 2 shows a part of the security document according to the invention and its embodiments. The security document or a part thereof comprises at least two layers, namely a basic layer or a substrate layer and a coating layer. In FIG. 2, the document has a first layer, which can be any printable material, e.g. of paper or of paper-based material or polycarbonate 2-2 and a second layer of an optically variable ink 2-4. Optionally, between the first layer and the second layer, there can be provided an intermediate layer or a third layer 2-6. This third layer can be of fluorescing ink or an ink with some other optical properties deposited under the optically variable ink for providing an additional UV effect. The third layer can have optical properties, which are different from those of the first layer and the second layer.

All layers can consist of only one material. Alternatively, all layers can comprise two or more materials. E.g. the optically variable layer of mainly optically variable ink can also have fluorescing material in the layer so that two or more effects can be achieved from one layer. The other materials can also be for effecting and controlling the adhesion of different layers, the printability, the strength, hardness, toughness, shock resistance, density, corrosion tolerance, thermal conductivity, electrical conductivity and magnetic effects of the layer and the price of the layer.

The fluorescing ink can cause one or more optical and/or fluorescing effects like bi-fluorescing with two different fluorescing inks and effects, tri-fluorescing with three different fluorescing inks and effects, phosphorescing to exhibiting phosphorescence, up-converting from a lower frequency signal to a higher frequency signal, and the absorbance of frequencies/transparency in frequency in specific wavelengths.

In one embodiment, the security document comprises two or more OVI layers and/or two or more fluorescing layers superimposed or overlapping or on top of each other. Said layers can also alternate. E.g., the layers two and three can both be OVI layers or fluorescing layers. If the structure comprises e.g. four layers above the basic layer, they can be e.g. a first OVI layer, a first fluorescing layer, a second OVI layer and a third OVI layer.

The first layer can be white paper or paper with one or more colours. The third layer can be printed above the first layer e.g. by the offset printing method and the second layer can be printed above the third layer e.g. by the offset printing or by silk screen printing method.

In other words, the security document 1-1 comprises at least a first layer 2-2, the first layer being any printable layer, e.g. a paper based layer or of polycarbonate, a second layer 2-4 above the first layer, the second layer being of or comprising optically variable ink and one or more personalization elements. The second layer comprises one or more partly 2-14 or wholly optically variable ink free areas 2-12, 2-16, 2-21 that are optically variable elements of the one or more personalization elements. The shape of the ink free area e.g. edges, corners and cuts and the bottom area produces one or more optically variable effects. This means that he optically variable elements and/or the fluorescing variable elements can comprise ink free areas and/or areas with ink. In one embodiment the ink free area and the area with ink together form said elements and security document of part of it.

The security document can further comprise the third layer 2-6 between the first layer and the second layer, the third layer being of or comprising fluorescing ink. If the second layer comprises one or more wholly ink free areas until the third layer, it allows the third layer to fluoresize as one or more fluorescing variable elements of the one or more personalization elements, because the third layer can now be seen under the second layer. Thus, the shape of the ink free area e.g. edges, corners and cuts and the bottom area can now produce one or more fluorescing variable effects. Moreover, the third layer can comprise, under the totally optically variable ink free areas 2-16, 2-21 of the second layer, one or more partly or wholly fluorescing ink free areas 2-18, 2-22 that are optically variable elements of the one or more personalization elements. This is because the third layer can be removed such that the layer below it is revealed and can be seen.

The first layer can comprise one or more cavity areas 2-23 or hills that are optically variable elements of the one or more personalization elements. The cavity areas in the first layer can be smaller than the ink free areas in the third and in the second layer. The ink free areas in the third layer can be smaller than the ink free areas in the second layer.

The layered structure 2-1 as shown in FIG. 2 can be provided to one or more parts of the security document. In addition to this layer structure, the document can comprise a structure 1-5 with one or more windows 1-12. These structures can be e.g. on different pages of the passport, as shown in FIG. 1. On the contrary, they can also be on the same page or base material. The structure with the window can be detached to the other part of the security document (1-1) and said structure can be movable in relation to at least one other part of the security document (1-1). In a booklet, e.g. in the passport the inner cover can have the OVI element and thus the two or more ink-layered structure and the data page can have the window. The data page is attached by binding, gluing or by adhesive bonding to the inner cover of the booklet, e.g. of the passport at one end, and the data page can be turned or moved in relation to the inner cover. The window page or some other part of the security document can also be removably detached to the security document.

According to one embodiment, the one or more optically variable ink free areas 2-12, 2-14, 2-16, 2-21 in the second layer and/or in the third layer 218, 2-22 and/or the one or more cavity areas 2-23 in the first layer and/or the one or more windows 1-12 are arranged together to form the one or more personalization elements.

In the method of the invention and its embodiments, in the first phase, a first layer of the security document is provided, the first layer comprising e.g. paper based material or polycarbonate. The next phase can comprise printing a second layer of the security document above the first layer, the second layer being of optically variable ink, and the third phase can comprise removing selectively the optically variable ink at least partly for producing one or more optically variable elements of the one or more personalization elements. In the removing phase, the second layer is removed from the areas, where there initially exists the second layer. In other words, the removal of the optically variable ink is made from the areas, where the optically variable ink was printed before removing step. Similarly, the removal of the other layers like e.g. the fluorescing variable ink layer(s) or other optically variable ink layer(s) is made from the areas where these layers initially exist.

The removal of different areas also comprises the removal by ablating, engraving, by etching and/or by other techniques.

The method can further comprise printing a third layer of the security document before printing the second layer of the security document so that the third layer is located between the first layer and the second layer, the third layer being of fluorescing ink or optically variable ink and then, if required or needed, further producing one or more fluorescing variable elements or optically variable elements of one or more personalization elements by removing the optically variable ink so that it extends to the third layer.

One or more further or other optically variable elements of the one or more personalization elements can be produced by removing the fluorescing variable ink so that it extends to the first layer. Thus, in the security document, there can be ink free areas and areas with ink.

The removing at least partly the second layer or the second layer and the third layer can be processed by at least a low power laser beam for producing the one or more optically variable elements and/or the one or more fluorescing variable elements of the one or more personalization elements.

Alternatively or in addition to this, a variable power laser beam can be used for producing one or more optically variable elements and/or one or more fluorescing variable elements of the one or more personalization elements with different shades. In either case the laser beam can be directed such that the one or more ink free areas in the third layer are aligned to the one or more ink free areas in the second layer. The low power laser beam and/or the variable laser beam can be directed through a window locating outside of the document or being in the document, as will be described.

Thus, in the first phase of the personalization or the authentication, personal, authentication or other data can be printed to the paper of the document or the security device e.g. by the offset printing method. The offset printing or the silk screen printing can be used for specified form background printing objects, which are the same in every document or in every set of the document. The personalization can be made by ink jet printing or by laser printing, if the substrate is of paper or is of mainly paper. If the substrate is of polycarbonate, the laser can be used, and if the substrate has of some other plastic surface or even polycarbonate by some sort of thermal transfer printing. The ink jet printing can also be used for plastic surfaces.

In the second phase, personal, authentication or other data is provided to the first layer, to the second layer and/or to the third layer of the security device or the security document by one or more laser beams and one or more laser powers. As an embodiment of the invention, the one or more laser beams and laser powers can be guided through the one or more windows to process the laser removal. The personalization and authentication can be seen as fluorescing colour, which is revealed under the OVI ink under the UV light, as the OVI ink or a special colour under the IR light, as the OVI ink itself unaided under the sun light and/or either as such or in combination with the one or more windows used and/or with other see-through elements. The different colours and/or effects are possible, because of the shaping or editing of the OVI layer by the laser personalization.

Alternatively, a plasma remover or any other remover that can remove the OVI ink layer and/or the fluorescing ink layer and/or affect, in one embodiment to the window and/or through the window, can be used instead of the laser remover.

The such processed security device or security document can have the personalization or the authentication in one or more inks and/or in one or more colours.

The structure disclosed in FIG. 2 can be at least in one location of the document. In one embodiment, the whole data page 1-5 can have the three-layer structure. In another embodiment, only a part of the data page has said structure. In yet another embodiment, the data page and both of the covers have said structure. The part of the document can have said structure on a paper data page, on one paper visa page, e.g. to the inner cover. Other documents like banknotes can have said structure on part of the surface or outer surface of the document.

As described, the security document can be personalized with one or more optically variable elements by using e.g. a suitable ink and a laser technique for removal of said ink. The usable ink has preferably a complicated production procedure and high anti-forgery reliability. Furthermore, the ink should have high resistance to environmental factors such as sunlight, moisture and wear.

If the optically variable ink, the OVI ink, is used as a marker in important documents as an anti-counterfeiting measure, it can be silk screen printed or offset printed on the substrate of the document, e.g. on the paper. If the three-layer structure is used, the OVI ink can be provided on the fluorescing ink layer. The OVI ink is most suitably printed by silk screen, because the ink consists of large particles. These particles cannot be handled by inkjet printing or by laser printing to have enough thick layer of the OVI ink. The optically variable inks are preferably used, because they contain metal, e.g. in the form of tiny flakes of a special film or of metal flakes or of tiny metal sticks or spheres. Metal particles change colour as the viewing angle of the element containing the OVI ink is varied.

Thus, depending on the angle of incidence of light, the OVI ink reflects different wavelengths of white light. As a result, a colour change can be detected or felt, when viewed with an unaided eye while the viewing angle is changed. When viewed under the sun light, the ink gives e.g. two colours with optical variation and sharp colour change. This is because the ink has a colourful metal luster with two or more colours. The combinations of colours can be e.g. green and blue, red and green, gold and silver or gold and orange.

The OVI element or the structure with the OVI element can be printed as a compact surface. This means that the OVI area and/or the contour of the shape of the security device have full ink coverage so that the thickness of the ink defines the contour.

The OVI layer can be provided over some area of the document. Alternatively, the OVI ink may be used only in small areas of the document e.g. to mark different identity marks, signs or emblems. For the line personalization or the authentication, there must exist enough thickness or width for the metal line or mark or enough surface or area for the personalization or the authentication so that the colour and the colour changes and the personalization and the authentication work and function. In other words, the OVI ink has sufficient area after the personalization by the removal of the OVI ink. For the compact surface personalization or authentication, there must exist enough surface or area for the personalization or the authentication so that the colour and the colour changes and the personalization and the authentication work and function. In other words, the OVI ink has sufficient area after the personalization by the removal of the OVI ink.

The personalization elements can be made to all of the three layers in the three-layer structure. To the first layer of printable material, like paper or polycarbonate 2-2 the security elements can be produced by offset printing. To the second layer of the optically variable ink 2-4 the security elements can be produced by silk screen printing. To the third layer 2-6 of fluorescing ink the security elements can also be produced by offset printing. In case of the two-layer structure, the same printing steps and materials are used.

After the printing phase, a very low laser power can be used to achieve a well controlled removal of the ink in a second phase. This works well with different kind of inks, like with the de facto standard OVI ink from the manufacturer SICPA. Thus, the use of personalization lasers can be combined with optically and/or fluorescing variable inks to achieve optically and/or fluorescing variable personalization.

The laser power can be such chosen that the metal colour of the OVI layer is removed due to the energy transmitted or heat induced by the power, but that the fluorescing colour or the layer under the OVI layer is not removed. In other words, the first layer can have the first heat resistant value, the second layer can have the second heat resistant value and the third layer can have the third heat resistant value. The second value can be lower than the third value.

FIG. 3 shows a part of the personalization of the security document according to the invention and its embodiment. The personalization or the authentication can utilize both positive removal and negative removal. If e.g. an identity number 3-4, 3-8 is used, the area 3-2 of each digit of the number can be removed or the area 3-6 outside of each digit of the number can be removed. Also positive and negative removal can be combined.

There exist many effects, which can be achieved by using the laser personalization of the optically variable element. When the serial number of the document is written on the document, the number, which is printed to the substrate material, appears as holes through the OVI ink, because the laser can penetrate through the OVI ink layer. The photograph or another sign can be personalized into the OVI ink, whereby variable power can be used to remove the OVI ink only partially thus obtaining different shades of colour, when the document is viewed in different viewing angles. The serial number or the photograph of the holder can also be prepared as a negative image such that the laser is used to remove the OVI ink except from the area of the characters or the photograph. Moreover, it is possible to personalize the photograph as the positive or the negative image, the latter of which provides further security to the document as any changes to the main photograph on the data page would need to be done in reverse this second image.

The only limitation in using said ink is that the ink has to be on the document surface thereby making the ink unusable for e.g. plastic cards where the printing is inside the plastic. However, it is possible to first make the ink layer and only after that to coat the object by a plastic material or by other material.

With reference to FIGS. 1 and 2, there exist many different implementations of the invention and its embodiments. If the data page 1-5 is of paper, the surface is accessible to the laser. Thus the personalization can be made onto the surface of the paper data page e.g. by printing an OVI patch onto the data page and utilizing the applications mentioned above. In the paper data page this printed feature can also be seen in back light, when holding the page against a light source with further visuality. The personalized element can also be made on the first page of the document 1-8, which page can be opposite to the data page. This provides more area and more possibility for the personalizing elements and for security elements as the first visa page is seen at the same time as the data page and therefore serves as a natural location for further personalized elements. This implementation works for both paper and synthetic data page.

In a third exemplary implementation the plastic data page of the security document like the passport comprises one window. The OVI element can be placed on the inner cover 1-10 of the document such that the personalization is done through the window. The personalization can be verified both through the window and on the inner cover when turning the data page. Alternatively, the personalization can be achieved as a co-operative action or as an interaction of the window and the inner cover with the element.

Instead of the above method or in addition to it, the third layer can be attached between the first layer and the second layer. The third layer can be the fluorescent ink layer. It is thus possible to print a patch of fluorescent ink behind the OVI patch. After the printing step, it is possible in the next step to selectively remove the OVI ink revealing the fluorescent ink from behind the OVI ink. In this way the laser does not only do optically variable personalization but also fluorescent variable personalization.

When the OVI ink is removed from a paper substrate e.g. by a laser, the offset printing behind the OVI ink can remain intact and in particular one can still see UV fluorescent inks there.

The window can be in the document to be personalized. The window can also be as a separate window not to be attached to the document. In one application the document is personalized such that the laser power is directed to the window causing carbon particles, which are in the window, to detach from the window and to move, flow or proceed to the OVI layer. Due to heat or heat delivered to the OVI layer, the layer or the metal colour of the layer is removed and the fluorescing layer is revealed behind the OVI layer. When the fluorescing layer is revealed, said layer can be seen under the UV light providing fluorescent variable personalization. If only a two-layer-structure is used, the delivered heat can remove the OVI layer and the basic layer is revealed behind the OVI layer. Depending on the basic layer different personalization effects can be seen through the OVI layer. In one application the polycarbonate layer or the paper can be affected by the laser removal providing e.g. different shades of colour grey, when the document is examined. Thus the security document can be individualized or personalized with removing the name of the owner of the document through the OVI ink layer to the fluorescing layer and/or to the basic layer. It is also possible to see the produced element and/or picture on the OVI layer. It is to be noted that the personalization can be made either as a positive image or a negative image to each of the layers.

E.g. the inner cover of the passport can have personal data printed thereon. The fluorescing and the OVI layers can be on the paper. The first passport page can be polycarbonate or of other suitable plastic material with a window area provided with carbon particles. When the laser beam is directed to the window, these carbon particles travel through the window destructing the

OVI colour but leaving the other layers untouched. If e.g. a number is to be removed via the OVI layer, the metal colour is removed from the number area and this number is seen under the UV light. The number can also be seen from the OVI layer. Also the window can have this number. The personalization can be such produced that the number is visible unaided or aided from as many layers as possible or only from some predetermined layers.

There can be a number of window areas or window stencils or templates or both of them for personalizing the security document. If the window is in the document, the thickness of the window can substantially be the same as the thickness of the material to which the window is attached or integrated. The thickness of the window can be e.g. as thick as the data page of the passport.

A typical document examination covers visual inspection including viewing the document from different angles, wherein the OVI ink changes colour in different viewing angles; inspection the document under ultraviolet light, under the UV light, wherein the light fluorescent ink is seen under the UV light; and even by standard passport readers under the infrared light, under the IR light, wherein the removal of the OVI ink is seen as a negative image under the IR light. In all of these cases personal data can be left visible.

The invention and its embodiments provide the advantage that data used in many different security documents using typically either security items of visible colours or with a UV fluorescent component or being of polycarbonate and processed with the laser removing technique causing shades of grey to be visually detected, is not easy to mimic or reproduce, although counterfeiters would obtain a blank document or would manage to erase legitimate data on a stolen document. Thus, the security is increased even further against these situations by security printing the different security features and markings according to the invention and its embodiments.

These security features and markings can be used together with other security devices and personalization and authentication data like holograms.

The invention and its embodiments provide improved security of different security documents against counterfeiting attempts e.g. by means of redundant personalization data to the documents.

Also many other advantages can be achieved by the invention and its embodiments. These comprise completely new type of ink and effects made available for personalization. For paper data pages and paper areas, the personalization can be made using the laser technique. For plastic data pages and plastic areas, the personalization is typically just black and white generated by the laser removing, while other techniques enable different colours. The present invention and its embodiments enable the above described OVI personalization and if needed, at the same time many different kinds of colour personalizations on two pages, and fluorescing variable effect to the personalization.

It will be obvious to a person skilled in the art that, as the technology advances, the inventive concept can be implemented in various ways. The invention and its embodiments are not limited to the examples described above but may vary within the scope of the claims.

1. A security document (1-1), comprising at least
a first layer (2-2), the first layer (2-2) being of printable material;
a second layer (2-4) above the first layer (2-2), the second layer (2-4) comprising optically variable ink; and
one or more personalization elements (3-2, 3-6),
wherein the second layer comprises one or more partly or wholly optically ink free areas (2-12, 2-14, 2-16, 2-21); and
wherein the one or more personalization elements (3-2, 3-6) comprises one or more optically variable elements formed at least by means of the one or more partly of wholly optically variable ink free areas (2-12, 2-14, 2-16, 2-21) in the second layer (2-4).

2. The security document (1-1) according to claim 1, wherein the one or more partly or wholly optically variable ink free areas (2-12, 2-14, 2-16, 2-21) are initially areas with optically variable ink.

3. The security document (1-1) according to claim 1, further comprising a third layer (2-6) between the first layer (2-2) and the second layer (2-4), the third layer comprising fluorescing ink and one or more partly or wholly fluorescing ink free areas, and wherein
at least one of the one or more personalization elements (3-2, 3-6) comprises one or more fluorescing variable elements formed at least by means of the one or more partly of wholly fluorescing variable ink free areas (2-18, 2-22) in the third layer (2-6).

4. The security document (1-1) according to claim 1, further comprising a third layer (2-6) between the first layer (2-2) and the second layer (2-4), the third layer being another layer comprising optically variable ink, and wherein
the second layer (2-4) comprises one or more wholly ink free areas (2-12, 2-16, 2-21) that allow the third layer (2-6) to produce one or more further optically variable elements of the one or more personalization elements.

5. The security document (1-1) according to claim 3, wherein the third layer (2-6) comprises, under the optically variable ink free areas (2-16, 2-21) of the second layer (2-4), one or more wholly ink free areas (2-18, 2-22) that are optically variable elements of the one or more personalization elements.

6. The security document (1-1) according to any one claim 1, wherein the first layer (2-2) comprises one or more cavity areas (2-23) that are optically variable elements of the one or more personalization elements.

7. The security document (1-1) according to claim 5, wherein the cavity areas (2-23) in the first layer (2-2) are smaller than the ink free areas (2-18) in the third layer (2-4) and/or wherein the ink free areas (2-18) in the third layer (2-6) are smaller than the ink free areas (2-16) in the second layer (2-4).

8. The security document (1-1) according to claim 1, wherein the security document (1-1) further comprises one or more window (1-12) of see-through material in the document (1-1).

9. The security document (1-1) according to claim 1 further comprising a structure, the structure comprising one or more windows of see-through material and which structure is detached to the security document (1-1) and movable in relation to the security document (1-1).

10. The security document (1-1) according to claim 1, wherein the security document (1-1) is included in a passport document, an identity card, a driver's license, a credit card, a membership card, a phone card, currencies, a banknote, a bond, a share, a stamp, a value document, a value product or in a product sign for alcohol, pharmaceuticals, food, beverages, or for luxury goods, like handbags, briefcases, ballpoint pens, pencils, cigars, shoes, ties.

11. The security document (1-1) according to claim 1, wherein the one or more personalization elements are positive image elements and/or negative image elements and/or compact surface elements or elements with redundant data.

12. The method of manufacturing one or more personalization elements to a security document (1-1), comprising at least
printing a second layer (2-4) comprising optically variable ink over a first layer (2-2) comprising printable material,
removing selectively the optically variable ink at least partly from the second layer for producing one or more optically variable elements of the one or more personalization elements.

13. The method according to claim 12, further comprising
printing a third layer (2-6) before printing the second layer (2-4) so that the third layer (2-6) is located between the first layer (2-2) and the second layer (2-4), the third layer (2-6) comprising fluorescing ink; and
removing wholly the optically variable ink from at least part of the second layer for further producing one or more fluorescing variable elements of the one or more personalization elements.

14. The method according to claim 12, wherein the removing step comprises
removing at least partly the second layer (2-4) or the second layer (2-4) and the third layer (2-4) by at least a low power laser beam (2-10).

15. The method according to claim 12, further comprising
removing at least partly the second layer (2-4) or the second layer (2-4) and the third layer (2-4) by at least a variable power laser beam (2-10) for producing one or more optically variable elements and/or one or more fluorescing variable elements of the one or more personalization elements with different shades of colour.

16. The method according to claim 14, comprising
directing the laser beam (2-10) such that the one or more ink free areas (2-18, 2-22) in the third layer (2-6) are aligned to the one or more ink free areas (2-16, 2-21) in the second layer (2-4).

17. The method according to claim 16, further comprising
directing the laser beam (2-10) such that the ink free areas (2-18) produced in the third layer (2-6) are smaller than the ink free areas (2-16) in the second layer (2-4).

18. The method according to claim 12, comprising removing selectively the optically variable ink or the optically variable ink and the fluorescing variable ink through a structure with one or more windows.

19. The method according to claim 18, comprising
directing the low power laser beam (2-10) or a variable power laser beam (2-10) through the one or more windows (1-12) for releasing carbon particles from the one or more windows (1-12) for producing the one or more personalization elements to the one or more windows (1-12) and/or to the second layer (2-4) and/or to the third layer (2-6) an/or to the first layer (2-2).

20. The method according to claim 12 wherein the security document (1-1) is a passport document, an identity card, a driver's license, a credit card, a membership card, a phone card, currencies, a bond, a share, a banknote, a stamp, a value document or a value product or a product sign for alcohol, pharmaceuticals, food, beverages, or for luxury goods, like handbags, briefcases, ballpoint pens, pencils, cigars, shoes, ties.
